(19) United States
(12) Patent Application Publication
(10) Pub. No.: US 2014/0358434 A1
(43) Pub. Date: Dec. 4, 2014

(54) Peer-Assisted Dead Reckoning

(71) Applicants: GUOBIAO ZHANG, CORVALLIS, OR (US); HANGZHOU HAICUN INFORMATION TECHNOLOGY CO. LTD., HANGZHOU (CN)

(72) Inventors: GUOBIAO ZHANG, CORVALLIS, OR (US); BRUCE BING WANG, SHANGHAI (CN)

(73) Assignees: HANGZHOU HAICUN INFORMATION TECHNOLOGY CO. LTD., HANGZHOU (CN); GUOBIAO ZHANG, CORVALLIS, OR (US)

(21) Appl. No.: 14/088,435

(22) Filed: Nov. 24, 2013

Related U.S. Application Data
(60) Provisional application No. 61/830,105, filed on Jun. 2, 2013.

(51) Int. Cl. G01C 21/12

(52) U.S. Cl. CPC G01C 21/12
USPC 701/501

(57) ABSTRACT

The present invention discloses a peer-assisted dead reckoning (PA-DR). When a first mobile device has a much larger location error than a second mobile device, its location can be optimized from that of the second device. For the first device, its optimized location is equal to the sum of the location of the second device and the relative location between two devices.

### CROSS-REFERENCE TO RELATED APPLICATIONS

This application claims priority of a provisional application entitled “Peer-Assisted Dead Reckoning”, Ser. No. 61/830,105, filed Jun. 2, 2013.

### BACKGROUND

1. Technical Field of the Invention

The present invention relates to the field of mobile electronic system, and more particularly to localization by dead reckoning.

2. Prior Arts

Dead reckoning (DR) is a process of calculating one's current location by using a previously determined location, and advancing that location based upon known or estimated speeds over elapsed time. For a mobile user carrying a mobile device 10 (FIG. 1A), dead reckoning uses the sensors (e.g. accelerometer and compass) of the mobile device 10 to track the mobile user. Based on the accelerometer reading, it is possible to tell whether the user has taken a step (each dot in FIGS. 1A and 1B represents a step), and therefrom estimate the displacement. Based on the compass reading, the direction of each step can be tracked. These numbers—displacement and direction—form the motion vector Sᵢ of the ith step taken by a user (FIG. 1A).

As illustrated in FIG. 1A, the area of interest comprises a plurality of reference points R₁, R₂ . . . At each reference point, the location of the mobile device can be accurately identified. A reference point could be a landmark which presents identifiable sensor signatures, e.g. an entrance or an elevator. It could also be a ground truth event (GTE) location where an explicit act is performed on behalf of or by the mobile user to specify the location of the mobile user or the mobile device. For example, a mobile user may manually input a location or take a location-related image. Whenever the mobile user crosses a reference point (e.g. R₁), the localization error is set to zero.

Dead reckoning estimates the location of a mobile device (referred to as its DR location) by adding motion vectors of all steps walked from the last reference point. Because of the noisy sensors, the DR location suffers from accumulation of errors. The DR error can grow cubically with the total number of steps walked from the last reference point (FIG. 2). Overall, the DR error exhibits a saw-tooth behavior—over time, the error grows and then sharply drops to zero at the next reference point, and then grows again. This becomes worse if the mobile user runs errands between reference points. For example, the path P of FIG. 1A includes an extra rectangular portion ABCD. The extra steps taken to walk along the ABCD cause large errors to be built up, as shown in the error curve E of FIG. 2.

Kramer et al. (“A-GNSS a different approach”, Inside GNSS, Sep./Oct., 2009, pp. 52-61) taught a peer-to-peer dead reckoning (P2P-DR) to improve the DR accuracy. It optimizes the DR location of a first device when it meets a second device with a different DR error (at a meeting location M of FIG. 1B). At this point, their common DR location is calculated based on weighted average of their respective DR locations using the reciprocals of their respective error variances as weight. If the first device has an excessively larger DR error than the second device, the location of the second device is essentially used as their common DR location, and the error of this common DR location is roughly equal to that of the second device. As shown in the error curve E* of FIG. 2, the localization error of the first mobile device 10 at the meeting location M drops sharply to that of the second device 10*, whose error accumulates only along the path P* and is much smaller. Apparently, P2P-DR reduces the DR error.

Although P2P-DR improves the DR accuracy, it is limited by the probability that two mobile devices meet (in Kramer, a distance <2 m is required), whose occurrence depends on the device density in the area of interest and is totally random. In practice, P2P-DR has a very limited applicability.

### OBJECTS AND ADVANTAGES

It is a principle object of the present invention to improve the accuracy of dead reckoning (DR).

It is a further object of the present invention to improve the applicability of peer-to-peer dead reckoning (P2P-DR).

In accordance with these and other objects of the present invention, the present invention discloses a peer-assisted dead reckoning (PA-DR).

### SUMMARY OF THE INVENTION

The present invention discloses a peer-assisted dead reckoning (PA-DR). It optimizes the locations estimated by dead reckoning (i.e. DR locations) using assistance from peers, i.e. nearby mobile devices. Unlike P2P-DR which requires two mobile devices to meet, PA-DR allows two spaced-apart devices to assist.

Let's assume that a first device has a larger DR error than a second device. To take advantage of the smaller DR error of the second device, the relative location (including distance and direction) between two mobile devices is measured. This measurement is preferably carried out with an acoustic (or, EM) ranging method. It is well known to those skilled in the art that the acoustic (or, EM) ranging method has a high accuracy of ˜2%. For a distance of 10 m, the error is ˜20 cm.

Then a derived location of the first device is derived by adding the DR location of the second device with the relative location between the first and second devices. The optimized location for the first device (referred to as its PA-DR location) is equal to the weighted average of this derived location and the DR location of the first device using the reciprocals of their respective error variances as weight. If the first device has an excessively larger DR error than the second device, the derived location is essentially used as the PA-DR location for the first device, and the error of the PA-DR location is roughly equal to the DR error of the second device. Hence, PA-DR significantly reduces the DR error. More importantly, because it does not require two devices meet, PA-DR has a much broader applicability than P2P-DR.

### BRIEF DESCRIPTION OF THE DRAWINGS

FIG. 1A illustrates a path P taken by a mobile device 10; FIG. 1B illustrates two path P, P* taken by two mobile devices 10, 10* which meet at point M;

FIG. 2 compares the error curves E, E* for the mobile device 10 from FIGS. 1A and 1B, respectively;

FIG. 3 illustrates the estimated locations and their error variances for several mobile devices during different steps of peer-assisted dead reckoning (PA-DR);

FIG. 4 is a flow chart of a general process for PA-DR;

FIG. 5 is a functional block diagram of a preferred PA-DR system;

FIG. 6 discloses a preferred method to measure relative location between two mobile devices.

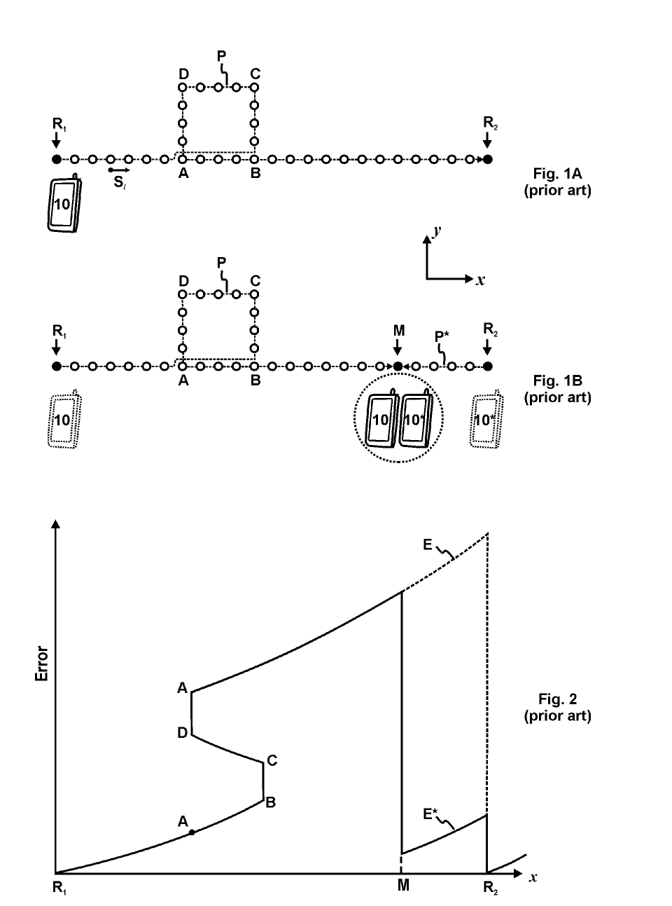

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

Hereinafter, the symbol “/” means a relationship of “and” or “or”. “Location” of a mobile device includes the coordinates of the mobile device and is a vector; “DR location” means the location estimated by dead reckoning only; “PA-DR location” means the location estimated by peer-assisted dead reckoning. Vectors are represented by upper case while scalars are represented by lower case.

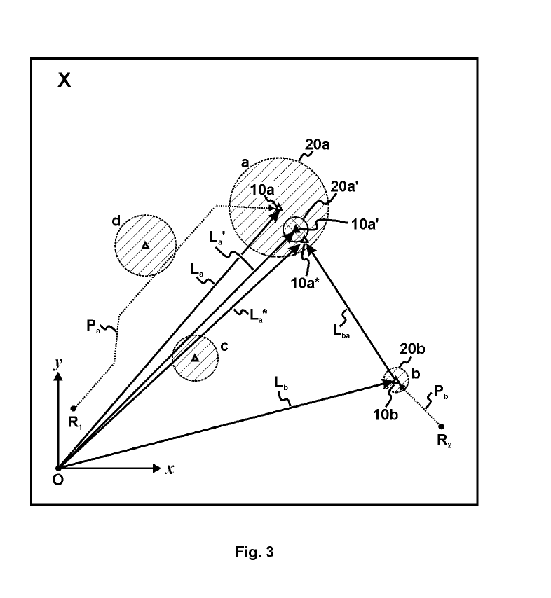

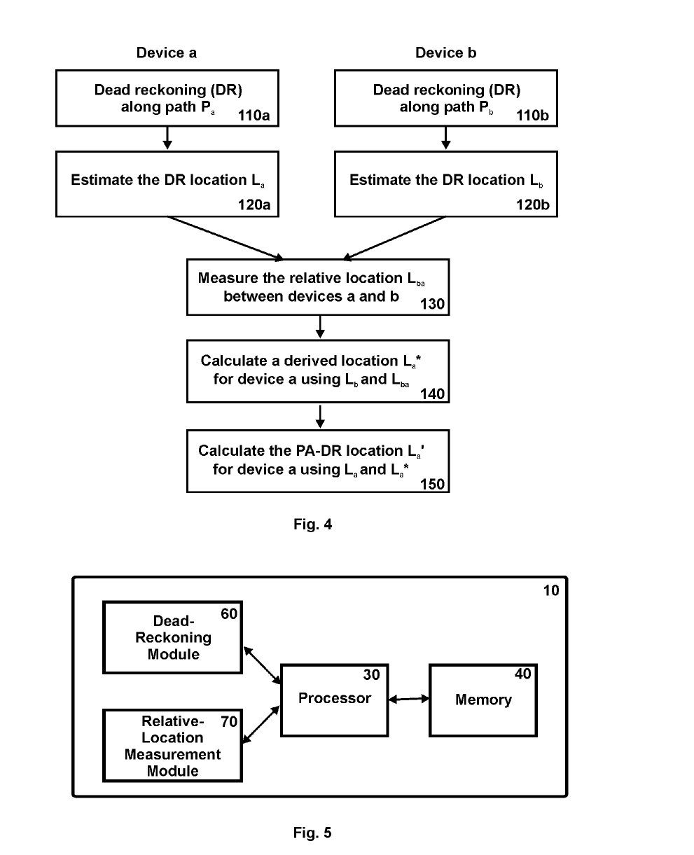

Referring now to FIGS. 3 and 4, a general process for peer-assisted dead reckoning (PA-DR) is disclosed. The area of interest X includes mobile users carrying four mobile devices a, b, c, d. Each device can be a variety of different types of devices, with different devices being the same or different types of devices. For example, device can be a cellular or other wireless phone, a laptop or netbook computer, a tablet or notepad computer, a personal computer, a mobile station, an entertainment appliance, a game console, an automotive computer, and so forth. Thus, device may range from a full resource device with substantial memory and processor resources to a low-resource device with limited memory and/or processing resources. Furthermore, because the concept of PA-DR can be applied to navigation of underwater vehicles, the mobile devices can be submarines.

A first user carrying a first device a walks along the path Pₐ from the reference point R₁ and estimates its location by dead reckoning (step 110a). At this point, its estimated location is the DR location 10a, which is also represented by vector Lₐ (step 120a). The circle 20a represents the error variance of the DR location 10a. Similarly, a second user carrying a second device b walks along the path P_{b} from the reference point R₂ and estimates its location by dead reckoning (step 110b). At this point, its estimated location is the DR location 10b, which is also represented by vector L_{b} (step 120b). The circle 20b represents the error variance of the DR location 10b.

Because the path Pₐ is much longer than the path P_{b}, the error variance 20a of the DR location 10a is much larger than the error variance 20b of the DR location 10b. If this error variance 20a exceeds a pre-determined threshold, the first device a may request “assistance” from its peers (e.g. nearby mobile devices), particularly from devices with a small DR error. On the other hand, if a device has a small DR error (e.g. below another pre-determined threshold), it may offer “assistance” to its peers (e.g. nearby mobile devices), particularly for devices with a large DR error.

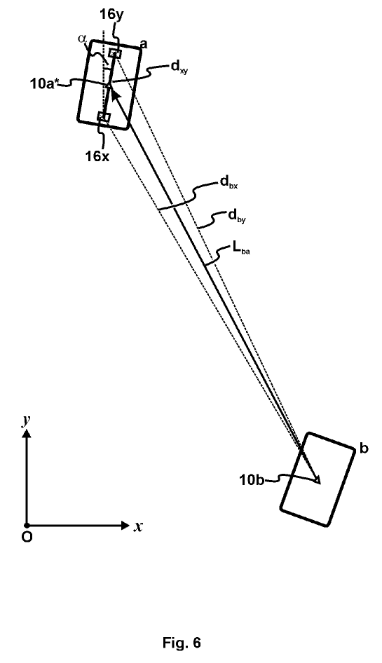

Once a second device b is recruited for assistance, the relative location L_{ba} (including their relative distance and direction) from the second device b to the first device a is measured (step 130). As will be disclosed in FIG. 6, this measurement can achieve a much higher accuracy (˜centimeter accuracy) than dead reckoning (˜meter accuracy). To take advantage of the small DR error of the second device b, the location of the second device b is used to derive the location of the first device a. This new location is referred to as the derived location 10a*. Its vector Lₐ* is equal to the sum of the DR location L_{b} of the second device b and the relative location L_{ba} from the devices a to b, i.e. Lₐ*=L_{b}+L_{ba} (step 140).

Accordingly, the error variance of Lₐ* is equal to the sum of the error variance of L_{b} and L_{ba}, i.e. var(Lₐ*)=var(L_{b})+var(L_{ba}). Because var(L_{ba}) is negligible compared with var(L_{b}), the error variance of the derived location 10a* is roughly equal to that of L_{b}, i.e. var(Lₐ*)≈var(L_{b}).

The optimized location for the first device a is referred to as its PA-DR location 10a′. Its vector Lₐ′ is equal to the weighted average of the DR location Lₐ and the derived location Lₐ* using the reciprocals of their respective error variances as weight (step 150), which can be expressed as:

Lₐ′=[Lₐ/var(Lₐ)+Lₐ*/var(Lₐ*)]/[1/var(Lₐ)+1/var(Lₐ*)].

Accordingly, the error variance of the PA-DR location Lₐ′ is,

var(Lₐ′)=1/[1/var(Lₐ)+1/var(Lₐ*)].

When the first device a has an excessively larger DR error than the second device b, the derived location Lₐ* is essentially used as the PA-DR location Lₐ′ for the first device a, i.e. Lₐ′≈Lₐ*, and its error variance is roughly equal to that of L_{b}, i.e. var(Lₐ′)≈var(Lₐ′≈var(L_{b}). Thus, PA-DR significantly reduces the DR error. More importantly, because it does not require two devices meet, PA-DR has a much broader applicability than P2P-DR.

Referring now to FIG. 5, the functional components of a preferred PA-DR system 10 are disclosed. The preferred PA-DR system 10 comprises a processor 30, a memory 40, a dead-reckoning module 60 and a relative-location measurement module 70. In some embodiments, the PA-DR system 10 may include many more components than those shown in FIG. 5. However, it is not necessary that all of these generally conventional components be shown in order to disclose an illustrative embodiment.

The processor 30 accepts digital data as input, processes it according to instructions stored in the memory 40 and provides results as output. The memory 40 is adapted to store software. Software includes a set of executable instructions, programs, and or program modules adapted to control the dead-reckoning module 60 and the relative-location measurement module 70.

The dead-reckoning module 60 receives sensor data and executes dead-reckoning algorithm to determine the location of the mobile device based on vector analysis of changes in the sensor data. It comprises a plurality of inertial sensors that detect movement, altitude, and/or direction. These inertial sensors can include accelerometer, compass, gyroscope, and so forth. They collect data regarding the detected movement, position, and/or direction of the device.

The relative-location measurement module 70 measures the relative location (including distance and direction) between mobile devices. It may use acoustic waves and/or electro-magnetic (EM) waves. The acoustic waves include audible sound, ultra-sound and/or other acoustic signals. On the other hand, the EM waves include laser, infra-red (IR), radio-wave (e.g. cellular, WiFi, Bluetooth, near-field communication signals) and/or other EM signals.

FIG. 6 illustrates a preferred method to measure the relative location L_{ba} from the device b (at location 10b) to the device a (at location 10a*). The distances d_{bx}, d_{by} between the device b and two spaced-apart signal receivers 16x, 16y on the device a are measured. Examples of two spaced-apart signal receivers 16x, 16y on a cellular phone are its primary microphone (for listening to the user's voice) and its secondary microphone (for monitoring the environmental noise). This measurement can be done by acoustic ranging (or, EM) ranging. Acoustic (or, EM) ranging have a much higher accuracy (centimeter accuracy) than dead reckoning (˜meter accuracy). The measurement principles range from signal strength measurement to time-of-flight (ToF) measurement. The ToF measurement further includes pulsed time measurement and continuous-wave measurement (e.g. phase-shift measurement). In the meantime, the distance d_{xy} between the receivers 16x, 16y is already known and the orientation angle α (with respect to the y axis in the x-y coordinate) of the device a can be easily measured by magnetometer or gyroscope. Combining the known d_{xy} and the measured d_{bx}, d_{by}, d_{by}, α the relative location L_{ba} can be calculated. In one example, the length of L_{ba} (i.e. distance) is measured from the time-of-flight of the acoustic signals traveling between devices a and b; the direction of L_{ba} (i.e. angle) is measured from the phase difference of the acoustic signals arriving at the receivers 16x, 16y from the device b. It should be apparent to those skilled in the art that, besides the above method, other distance-measurement and direction-finding techniques may also be used.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A peer-assisted dead-reckoning (PA-DR) system, comprising:
a first mobile device comprising a first dead-reckoning (DR) module for determining a first location for said first mobile device;
a second mobile device comprising a second dead-reckoning module for determining a second location for said second mobile device;
a relative-location measurement module for determining a relative location between said first and second mobile devices;
wherein an optimized location of said first mobile device is determined at least in part by said relative location and said second location when the error of said first location is larger than the error of said second location.

2. The PA-DR system according to claim 1, wherein the relative distance between said first and second mobile devices is larger than 2 meters.

3. The PA-DR system according to claim 1, wherein said first or second dead-reckoning module comprises at least one of an accelerometer, a compass and a gyroscope.

4. The PA-DR system according to claim 1, wherein said relative-location measurement module measures relative distance and direction between said first and second devices.

5. The PA-DR system according to claim 4, wherein said relative-location measurement module comprises at least two spaced-apart signal receivers.

6. The PA-DR system according to claim 1, wherein said relative-location measurement module uses acoustic waves.

7. The PA-DR system according to claim 6, wherein said acoustic waves are audible sound and/or ultra-sound.

8. The PA-DR system according to claim 1, wherein said relative-location measurement module uses electromagnetic (EM) waves.

9. The PA-DR system according to claim 8, wherein said EM waves are laser, infra-red (IR) and/or radio-wave.

10. The PA-DR system according to claim 1, wherein the error of said optimized location is smaller than the error of said first location.

11. A peer-assisted dead-reckoning (PA-DR) method, comprising:
using dead reckoning (DR) to determine a first location for a first mobile device;
using dead reckoning to determine a second location for a second mobile device;
measuring a relative location between said first and second mobile devices;
determining an optimized location of said first mobile device at least in part by said relative location and said second location when the error of said first location is larger than the error of said second location.

12. The PA-DR method according to claim 11, wherein the relative distance between said first and second mobile devices is larger than 2 meters.

13. The PA-DR method according to claim 11, wherein said dead reckoning uses at least one of an accelerometer, a compass and a gyroscope.

14. The PA-DR method according to claim 11, wherein relative location includes relative distance and direction.

15. The PA-DR method according to claim 14, wherein said relative location is measured with at least two spaced-apart signal receivers.

16. The PA-DR method according to claim 11, wherein said relative location is measured with acoustic waves.

17. The PA-DR method according to claim 16, wherein said acoustic waves are audible sound and/or ultra-sound.

18. The PA-DR method according to claim 11, wherein said relative location is measured with electromagnetic (EM) waves.

19. The PA-DR method according to claim 18, wherein said EM waves are laser, infra-red (IR) and/or radio-wave.

20. The PA-DR method m according to claim 11, wherein the error of said optimized location is smaller than the error of said first location.
